(19) United States
(12) Patent Application Publication
(10) Pub. No.: US 2009/0173194 A1
(43) Pub. Date: Jul. 9, 2009

(54) IMPACT WRENCH STRUCTURE

(76) Inventor: JUI YU CHEN, Tainan (TW)

Correspondence Address: LEONG C LEI, PMB # 1008, 1867 YGNACIO VALLEY ROAD, WALNUT CREEK, CA, 94598, US

(21) Appl. No.: 11/971,218

(22) Filed: Jan. 9, 2008

(51) Int. Cl. B25B 23/151; B25D 11/06; B25B 19/00; G01L 3/02; B25D 11/00

(52) U.S. Cl. 81/469; 173/104; 173/117; 81/57.18; 73/862.191

(57) ABSTRACT

A novel impact wrench is provided herein, which allows a user to set a target torque level, show the torque level in a display, and automatically stops the motor when the target torque level is reached. The impact wrench is constructed such that its electrical current would be at a maximum when it engages an impact operation, and at a minimum after the impact operation. The electrical current exhibits a periodic pulse and the periodic pulse is used to calculate the number of times of impacts. The torque level of the impact wrench could then be determined by the number of times of impacts.

### TECHNICAL FIELD OF THE INVENTION

The present invention generally relates to impact wrenches, and more particularly to an impact wrench whose electrical current is converted into periodic pulse as a base to torque control.

### DESCRIPTION OF THE PRIOR ART

FIG. 1 is a schematic sectional diagram showing a conventional impact wrench. As illustrated, the impact wrench contains a hand-held hollow body 1. Inside the hollow body 1, there is a reversible motor 11 with a transmission gear 111 at the output end. The transmission gear 111 engages a driven gear 121 which is mounted to a side of a wheel 12. Inside the wheel 12 is a clutch device 14 which interfaces the driven gear 121 and an output shaft 13 at the other side of the wheel 12. The output shaft 13 has a reception terminal 131 at the tip for mounting nuts of various sizes so as to drive different bolts. When the impact wrench is turned on, a switch 15 controls the axle of the motor 11 to spin either clockwise or counterclockwise. The clutch device 14, on the other hand, transforms the continuous drive of the motor 12 into intermittent drive to the output shaft 13 for fastening or loosing a bolt.

The impact wrench described above does not have an automatic mechanism to control the output torque and a user has to rely on his or her experience or has to carefully listen to the sound of operation. However, these are not reliable methods and the bolts are often fastened either too tight or too loose. Therefore, there are various teachings to automatically control the torque delivered by the impact wrench. Some examples are as follows. U.S. Pat. No. 6,892,826 uses a ferromagnetic sensor to measure the output torque of the output shaft. U.S. Pat. No. 5,563,482 uses a speed sensor to measure the electrical current in the motor and automatically stops the motor when an increase in the rate of change of the electrical current is detected. U.S. Pat. Nos. 6,371,218 and 6,598,684 use a microphone to monitor the impact sound level as a base for calculating the torque level for tightening a bolt or nut. U.S. Pat. No. 6,655,471 measures the duration and magnitude of torque pulse to obtain a fastener angular velocity and displacement, which in turn are converted to a torque signal. The impact tool is then controlled based on the value of the torque signal. U.S. Pat. No. 7,091,683 uses pulse-width modulation (PWM) to control the motor speed and the desired torque level is determined by monitoring the output of a Hall-effect sensor.

There are also various teachings about the control of torque. U.S. Pat. No. 5,014,793 controls the motor speed by using a zero displacement switch to produce an output voltage to the motor proportional to the pressure applied to the switch via the hand of the user. U.S. Pat. No. 6,111,515 employs a displacement sensor to measure the displacement of the output shaft as a base to torque control. U.S. Pat. No. 6,161,629 uses a sensor to measure the rotational angle of the output shaft as a base to torque control. U.S. Pat. No. 5,315,501 uses torque-time rate and torque-angle rate as a base to torque control. U.S. Pat. No. 5,650,574 relies on the relationship between torque and speed as a base to torque control. Finally, U.S. Pat. No. 5,245,747 uses the relationships between angular velocity, frequency, and voltages as a base to torque control.

The present inventor has also tree U.S. patents, U.S. Pat. Nos. 5,887,666, 6,119,794, and 6,283,226, teaching various improvements to the mechanical structure of impact wrenches. However, these teachings are also lack an appropriate automatic torque control mechanism.

### SUMMARY OF THE INVENTION

A novel impact wrench is provided herein, which allows a user to set a target torque level, show the target torque level in a display, and automatically stops the motor when the target torque level is reached.

The impact wrench is constructed such that its electrical current would be at a maximum when it engages an impact operation, and at a minimum when an internal clutch device prevents it from engaging an impact operation. The electrical current exhibits a periodic pulse waveform and the periodic pulse is used to calculate the number of times of impacts. The torque level of the impact wrench could then be determined by the number of times of impacts.

In contrast to conventional wrenches that rely on a sensor to obtain relevant signals, the present invention does not rely on such a sensor and therefore avoids the cost and the installation problem of such a sensor. The present invention provides a simple yet precise means to torque control that could be applied to various types of DC, AC, and rechargeable power impact wrenches.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic sectional diagram showing a conventional impact wrench.

FIG. 2 is a perspective exploded diagram showing the components of an impact wrench according to an embodiment of the present invention.

FIG. 3 is a schematic sectional diagram showing the impact wrench of FIG. 2.

FIG. 4 is schematic sectional diagram showing an impact wrench according another embodiment of the present invention.

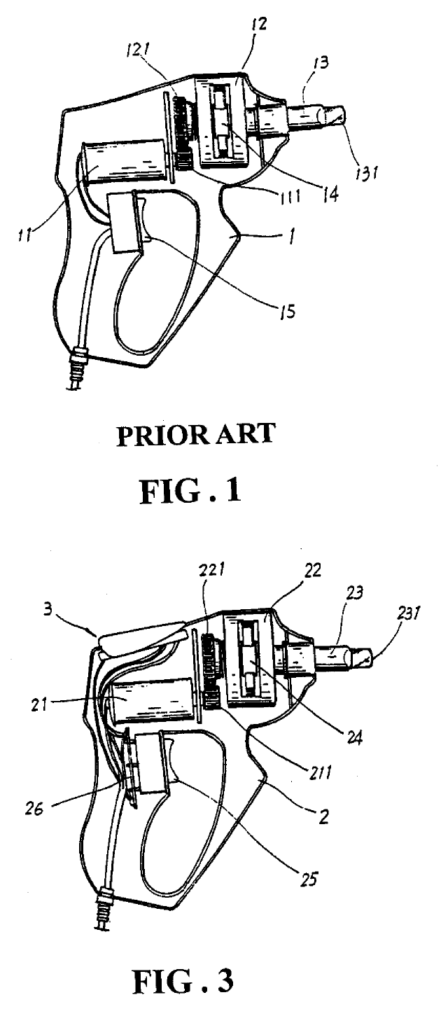

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

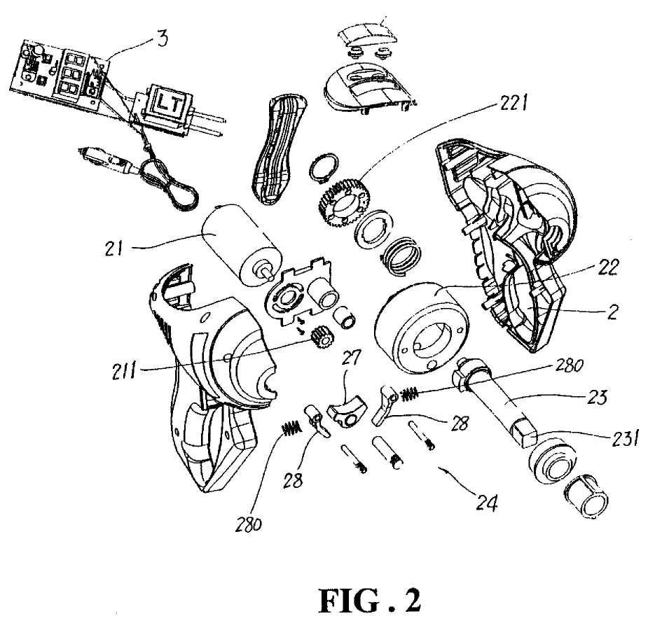

As illustrated in FIG. 2, an impact wrench according to an embodiment of the present invention contains a hand-held hollow body 2 with an internal reversible motor 21. A transmission gear 211 is axially mounted on an axle of the motor 21. The transmission gear 211 engages a driven gear 221 mounted to a side of a wheel 22. A clutch device 24 inside the wheel 22 interfacing the driven gear 221 and an output shaft 23 with a reception terminal 231 at a tip of the output shaft 23.

As also illustrated in FIG. 3, the impact wrench has an electronic actuating device 3 connecting a switch 25 via a control interface 26. When the impact wrench is turned on, a user can set a target torque level into the electronic actuating device 3 and the torque level is displayed in a display of the electronic actuating device 3. As the clutch 24 turns the continuous drive of the motor 21 into intermittent drive, the electronic actuating device 3 monitors the output torque and automatically stops the motor 21 when the target torque level is reached.

There are a large number of factors that could affect the output torque of the impact wrench. For example, the stability of the power voltage, the dimension of the bolt or nut being applied, and how the impact wrench is operated, just to name a few. Therefore an optimum output torque to fasten a bolt or nut is indeed difficult to determine. The present invention, by improving the mechanical structure of the impact wrench, could easily determine whether the impact wrench has reached the target torque level by monitoring the electrical current when the impact wrench is at a no-load condition and when the impact wrench is at a normal operation.

The conventional approaches mostly rely on a sensor to obtain relevant signals. However, the installation of such a sensor is a challenge, considering that the output shaft is in rotation. The present invention does not rely on such a sensor and therefore avoids the cost and the installation problem of such a sensor. On the other hand, the present invention provides a more precise means to torque control that could be applied to various types of DC, AC, and rechargeable power impact wrenches.

Impact wrenches could be roughly categorized into two types, based on their mechanical structures. One is the direct-impact type and the other one is the indirect-impact type. FIG. 2 shows how the present invention applied to an indirect-impact wrench. More specifically, the wheel 22 contains a hammer block 27 inside. Two clutch blocks 28 are positioned at two lateral sides of the hammer block 27, respectively. Each clutch block 28 is pressed against the hammer block 28 by a spring 280. When the motor 21 runs and the wheel 22 is turned, the clutch blocks 28 are spread apart due to the centrifugal force and the hammer block 27 therefore impacts the output shaft 23. At the moment, the electrical current would be at its maximum. After the impact operation is completed, the speed of the wheel 22 would gradually increase to a rating speed. When the wheel 22 rotates at a slow speed, the clutch blocks 28, without the centrifugal force, would be again pressed against the hammer block 27 by the springs 280. At this moment, the electrical current would be at its minimum. Therefore, during the entire process of fastening or loosing a bolt or nut, there is a relationship between the electrical current and the impact operations, and the number of times of impacts is a function of the torque level. As such, the number of times of impacts could be calculated and used as a base to torque control.

In other words, a major feature of the present invention is that, by improving the mechanical structure, the electrical current would be at its maximum when the output shaft engages an impact operation and at its minimum when the output shaft does not engage an impact operation. Therefore, the electrical current exhibits a periodic pulse waveform and the number of times of impacts inside the impact wrench could be calculated. In turn, by calculating and processing the number of times of impacts, whether a target torque level is reached and whether to stop the motor could be determined.

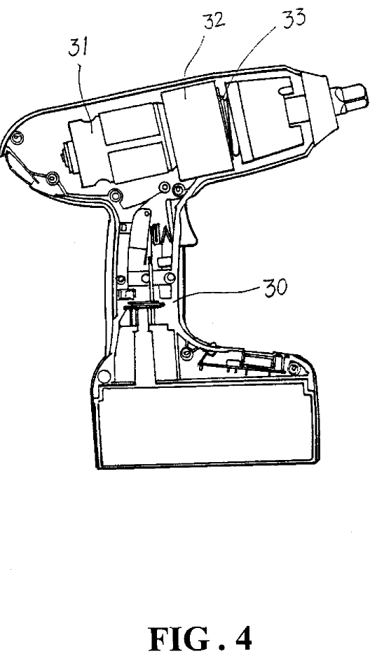

The present invention could be applied to direct-impact wrench as well, as illustrated in FIG. 4. The impact wrench has a hand-held hollow body 30 with an internal motor 31. A pressure ring 32 is axially mounted to the motor 31. When the motor 31 is operative, an internal gear assembly (which is a known prior art) would press the ring 32 against the spring 33. Then, when the ring 32 breaks loose, the spring 33 would press the ring 32 back. In this way, the ring 32 would be driven back and forth in the process of fasting or losing a bolt or nut. This type of direct-impact wrench, as there is not clutch device involved, could immediately produce impacts when it is turned on. Even though a direct-impact wrench usually produces weaker impacts, it could produce a very large number of impacts each second as the motor has a very high rotational speed. The number of times of impacts could be calculated and processed in accordance with the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. An impact wrench comprising:
a hollow body;
a wheel inside said body having a driven gear at a side, an output shaft at another side, and a clutch device inside said wheel interfacing said driven gear and said output shaft, said clutch device having a hammer block and two clutch blocks at two lateral sides of said hammer block, each clutch block being pressed against said hammer block by spring;
a motor inside said body having a transmission gear at an end of an axle of said motor, said transmission gear engaging said driven gear; and
an electronic actuating device having a display thereby allowing a user to set a target torque level and display said target torque level on said display;
wherein, when said motor is turned on, said wheel is spun and said clutch blocks spread away from said hammer block due to centrifugal force such that said hammer block engages an impact operation on said output shaft and an electrical current to said motor is at a maximum; and after said impact operation, said clutch block are pressed against said hammer block by said springs and said electrical current is at a minimum, thereby causing said electrical current to exhibit a periodic pulse waveform and enabling number of times of impacts inside said impact wrench to be calculated; said number of times of impacts is a function of torque level thus enabling torque level to be determined; when said target torque level is reached, said electronic actuating device will stop said motor thereby controlling torque applied to said impact wrench.
